(19) United States
(12) Patent Application Publication
(10) Pub. No.: US 2024/0075916 A1
(43) Pub. Date: Mar. 7, 2024

(54) ADAPTING A BRAKE CLEARANCE TO A TRAFFIC SITUATION

(71) Applicant: ZF Active Safety GmbH, Koblenz (DE)

(72) Inventors: Andreas Marx, Hartenfels (DE); Fabian Querbach, Lonnig (DE)

(21) Appl. No.: 18/458,396

(22) Filed: Aug. 30, 2023

(30) Foreign Application Priority Data
Sep. 2, 2022 (DE) 102022122254.3

(51) Int. Cl. B60T 13/74; B60T 7/04; B60T 8/172; B60T 8/32

(52) U.S. Cl. CPC B60T 13/741; B60T 7/042; B60T 8/172; B60T 8/32; B60T 2201/12

(57) ABSTRACT

The disclosure relates to a method for adapting a braking behaviour of a brake of a motor vehicle to a traffic situation, including: (i) adjusting a clearance of the brake to a value L_{K}; (ii) determining the traffic situation; and (iii) adjusting the clearance to a value L_{A} based on the determined traffic situation, wherein 0<L_{A}<L_{K} is satisfied.

### CROSS-REFERENCE TO RELATED APPLICATION

This application claims priority to German Priority Application No. 102022122254.3, filed Sep. 2, 2022, the disclosure of which is incorporated herein by reference in its entirety.

### TECHNICAL FIELD

The disclosure relates to a method for adapting a braking behaviour of a brake to a traffic situation and a computer program product with program code for carrying out the method.

### BACKGROUND

Conventional electro-hydraulic brake systems for motor vehicles are known to maintain a clearance between the brake lining and the brake drum or brake disc. At the same time, the clearance should be sufficiently large to reduce or even avoid undesirable residual grinding torques on the braking surfaces and the resulting loss of speed. On the other hand, the clearance should be as small as possible in order to enable rapid braking of the vehicle if necessary.

The generic EP 1 763 464 B1 concerns a method for electronic brake control. A brake system has a brake pedal/booster unit, a hydraulic unit with integrated electronic controller (EBS) and a hydraulically actuated brake assigned to a wheel. A brake cylinder of the brake is filled according to a selectable operating mode, if appropriate also automatically, in order to reduce the clearance at least partially.

The disadvantage here, however, is that the clearance changes over time due to the wear of the brake lining and the brake drum or disc. Furthermore, the clearance is also subject to constant changes during operation of the motor vehicle, for example due to the changing temperature of the brakes. The individual brakes of a motor vehicle can also have significantly different clearances. As a result, the individual brakes may have different response times and possibly braking forces, which will shift the centre of gravity of the motor vehicle during braking, especially emergency braking, destabilizing the motor vehicle which possibly gets out of control.

### SUMMARY

The disclosure relates to a method which takes into account the changing clearance so that during the entire operation of the motor vehicle on the one hand rapid braking of the motor vehicle is possible and on the other hand unnecessary grinding of the braking surfaces is avoided. The disclosure also relates to allowing a motor vehicle to brake evenly even with differently worn brake linings, without the motor vehicle swerving sideways, for example. Furthermore, the motor vehicle is not destabilised during braking, especially emergency braking.

The disclosure relates to a method for adapting a braking behaviour of a brake to a traffic situation, including: (i) adjusting a clearance of the brake to a value L_{K}; (ii) determining the traffic situation; and (iii) adjusting the clearance to a value L_{A} based on the determined traffic situation, where 0<L_{A}<L_{K} is satisfied.

In a first step (i) the clearance is set to a certain value L_{K}, in particular calibrated. In the context of the present disclosure, “clearance” is understood to mean the averaged distance between the brake linings, in particular their contact surface, the brake callipers or shoes and the friction surfaces of the brake disc or drum. The value L_{K} can be freely selected but is usually sufficiently large to avoid undesirable residual grinding torques on the braking surfaces, and at the same time sufficiently small to achieve an acceptable braking effect. Example values for L_{K} include 0.15 to 0.45 mm, such as 0.2 to 0.4 mm, or 0.3 mm.

In a further step (ii), the traffic situation is determined. In the context of the present disclosure, “traffic situation” is understood to mean a spatial and/or temporal configuration of traffic-related influencing variables (or influencing factors) of a working environment of road users. In principle, different types of traffic situations (or traffic events) are possible. These include, for example, environmental situations (or environmental events) that are not yet perceptible to the driver at a given point in time, but nevertheless influence his future driving behaviour, for example a traffic jam after the next bend. With the help of technical systems (for example navigation systems), such an environmental situation can be detected in advance and the corresponding knowledge can be made available to the driver. Another subset of traffic situations is formed by driving situations (or driving events) that are in principle perceptible from the driver's point of view, such as a pedestrian crossing a zebra crossing. The environmental situation and the driving situation are a traffic classification that does not take into account the driver himself. In addition, driver situations (or driver events) refer to the subset of traffic situations affecting the driver of a motor vehicle himself, which are therefore influenced by physical and psychological characteristics or conditions of the driver. An overlap between driving situations and driver situations is possible within the scope of the present disclosure.

A traffic situation can be detected directly by one or more sensors. These sensors can be located outside or inside the vehicle and provide corresponding sensor data to a control unit of the vehicle. In another exemplary arrangement, the traffic situation can be determined from the sensor data. Example recorded traffic situations include increased attention on the part of the driver of the motor vehicle, which can be recorded, for example, via a camera arranged in the interior of the motor vehicle. Increased attention can be inferred, for example, from the fact that the driver first takes his foot off the accelerator pedal, then only touches the brake pedal with this foot and thus prepares for possible braking. Furthermore, from a sensed actuation of the hazard warning lights it can be concluded that a braking process is imminent.

In response to the traffic situation determined in step (ii), the clearance is reduced to a value L_{A} in a third step (iii). This is greater than 0 and therefore excludes braking. At the same time, the value L_{A} is less than the preset, especially calibrated, value L_{K}, so that the traffic situation, which may require the initiation of a braking operation, is taken into account. This results in a shorter brake response time and overall enables a shorter braking distance without unnecessarily wearing the brake and wasting energy or emitting carbon dioxide. Another advantage, especially in the case of pairwise (axle-wise) or single actuation of the brakes of a motor vehicle, is that the individual brakes respond simultaneously and with the same force. This allows braking, in particular emergency braking, to be carried out smoothly in such a way that no destabilization of the vehicle occurs and the vehicle remains under the driver's control.

The value L_{A} is balanced in such a way that an excessively large gap between the brake lining and the friction surface, where the brake may take too long to respond due to a large clearance, and an excessively small gap between the brake lining and the friction surface are avoided. If the gap between the brake lining and the friction surface is too small, undesirable short-term contacts between the brake lining and the friction surface can occur, for example due to vibrations in the motor vehicle, which are transmitted to the chassis of the motor vehicle for example through the engine and/or an uneven road surface and thus possibly also to the brake, leading to unnecessary wear. Depending on the determined traffic situation, especially in the case of expected emergency braking, the clearance can nevertheless be reduced to such an extent that short-term contacts between the friction partners, for example due to vibrations in the motor vehicle, are accepted.

The determined traffic situation is weighted on the basis of a need to initiate braking. The determined traffic situation is assigned to certain alert levels, for example from one to five. If, for example, it is to be expected that a minor steering manoeuvre will require a slight braking or no braking of the vehicle, the clearance can only be reduced slightly, for example according to a value according to alert level one. On the other hand, the need for an early braking process can be inferred from the operation of the hazard warning lights, so that in this case the clearance is reduced considerably, for example according to a value according to alert level five. Determined traffic situations, which are weighted due to a necessity for the initiation of a braking process and are marked or weighted by an alert level, can be combined, for example added together, in order to obtain a better adaptation of the clearance to the determined traffic situation. For example, the successive determination of two traffic situations, each of which is marked or weighted with the same alert level, may result in changing the alert level to the next alert level by adapting, in particular reducing, the clearance. The determination of successive traffic situations that are marked or weighted with a different alert level may involve an adjustment of the alert level to the next higher alert level. For example, two consecutive traffic situations, each marked with alert level three, can lead to a change to alert level four with a simultaneous reduction of the clearance. Two consecutive traffic situations, the first of which is marked with alert level three and the second with alert level two, can lead to a change to alert level two with a simultaneous increase in the clearance. Two successive traffic situations, the first of which is marked as alert level two and the second as alert level three, can lead to a change to alert level three with a simultaneous reduction in the clearance.

The brake can be in the form of a disc brake, for example of a floating calliper brake or of a fixed calliper brake, or of a drum brake. For example, the brake is in the form of a floating camper brake.

The floating calliper brake has a housing with a brake cylinder in which a brake piston is connected, such as coaxially, via a spindle to a drive unit containing a motor and a gearbox. The brake piston may be sealed from the brake cylinder by a bellows, for example made of an elastic polymer, which provides protection against impurities, such as dust, and exerts a restoring force, for example after the brake has been actuated. The brake piston can be operated by a driver of the vehicle by a brake pedal via the drive unit and spindle.

Furthermore, the disclosure relates to a computer program product with program code for carrying out the method according to the disclosure and a control unit for adapting a braking behaviour of a brake of a motor vehicle to a traffic situation.

According to an exemplary arrangement, the clearance is set to a value L_{K} when the motor vehicle is at a standstill. The brake contains a brake lining with a contact surface and a friction surface, wherein setting the clearance to a value L_{K} involves the contact surface contacting (or coming into contact) with the friction surface and adjusting the clearance to the value L_{K} between the contact surface and the friction surface. The adjustment can be carried out with sensors. For example, the contact between the contact surface and the friction surface, i.e. a clearance set to a value L_{K}=0, can be determined by the degree to which the brake pedal is actuated. Force and/or torque sensors can be used to detect the establishment of contact or the contact surface contacting the friction surface.

Setting the desired distance between the contact surface and the friction surface to the value L_{K} can be determined, for example, by retracting the brake piston. This can also be carried out by force and/or torque sensors. Other suitable sensors that can be used include motor position sensors and sensors for determining the clamping force between the contact surface and the friction surface. The adjustment of the clearance when the motor vehicle is at a standstill allows the value L_{K} to be precisely adjusted, for example when the motor vehicle is used for the first time every day or every time it is stationary or stopped. As a result, the clearance of the individual brakes of a motor vehicle can be determined more precisely and a more uniform braking of the entire motor vehicle can be achieved.

Currently determined values L_{K} can be compared with values for L_{K} for already past periods, for example the previous day, week, or month, and if necessary corrected on the basis of these values for L_{K} for already past periods. As a result, the clearance of the individual brakes of a motor vehicle can be determined more precisely and more uniform braking of a motor vehicle can be achieved.

According to an exemplary arrangement, the clearance is readjusted each time the motor vehicle is at a standstill. As a result, the clearance of the individual brakes of a motor vehicle can be determined more precisely and more uniform braking of a motor vehicle can be achieved. This is of particular interest in the case of a sufficiently high degree of wear on the brakes of a motor vehicle, in particular due to age, or if the brakes of a motor vehicle have very different degrees of wear, for example when a single brake is replaced.

According to an exemplary arrangement, the method includes (iv) determining a changed traffic situation; and (v) adjusting the clearance to a value L_{B}, where 0<L_{B}≤L_{K} is satisfied with L_{B}≠L_{A}. The determination of a changed traffic situation, followed by a new adjustment of the clearance, enables the situation-dependent provision of sufficient braking power.

According to an exemplary arrangement, the traffic situation is a driving situation and/or a driver situation.

According to an exemplary arrangement, the method includes (iv) determining a change in traffic situation; and (v) adjust the clearance to a value L_{B} where 0<L_{B}<L_{A} is satisfied, wherein the traffic situation includes detecting a reduction in pressure exerted on an accelerator pedal of the motor vehicle, and the changed traffic situation involves detecting a pressure exerted by touching or actuating a brake pedal of the motor vehicle. As a result, changed traffic situations can be taken into account, each of which requires increased braking readiness.

According to an exemplary arrangement, the brake is an electromechanical brake. The motor vehicle can have multiple brakes, wherein the clearance of each of the multiple brakes is adjusted individually or axle-by-axle. In the case of an electromechanical brake, the clearance can be precisely determined and adjusted due to the electrical actuation. The single or axle-by-axle adjustment of the clearance allows more uniform braking, in particular emergency braking, of a motor vehicle, possibly without any or with only a slight loss of control by the driver. Adjustment of the clearance of all wheel brakes present in the motor vehicle can be carried out to the same value at the same time.

According to an exemplary arrangement, the method includes the use of a control unit, such as a driver assistance system, to provide a first control signal for adjusting the clearance and a second control signal for adapting the clearance to the brake. Here the control unit prepares the brake in conjunction with a drive unit, which includes a motor and, where appropriate, a gearbox. This allows the clearance of all brakes of a motor vehicle to be set to the same values, whereby a uniform effect, in particular response time, of all brakes and thus safe operation of the motor vehicle can be provided.

According to an exemplary arrangement, the method includes the use of a sensor adapted for determine the traffic situation and provide it to the driver assistance system. The sensor is adapted to detect one or more operating states of a brake, one or more operating states of a wheel provided with the brake, one or more operating states of an engine, and an action of a driver of the motor vehicle, in particular one or more operating states of a brake pedal and/or accelerator pedal of the motor vehicle. These sensors can include sensors already present in the vehicle, such as radar sensors, but also retrofitted sensors, such as a camera for capturing the driver. Alternatively or additionally, sensors located outside the vehicle, such as those of a central traffic monitoring system, can be used. From the sensor data obtained, one or more traffic situations can be determined. The determination of the traffic situations can be carried out with the help of an evaluation unit, in particular with the involvement of artificial intelligence. For example, the evaluation unit is integrated into an on-board computer (such as a driver assistance system) of the vehicle. Alternatively or additionally, the evaluation of the sensor data can be carried out by the sensor itself. By using a number of sensors, precise matching of the clearance to the determined traffic situation can be achieved.

The brake or wheel brake, the braking behaviour of which is adjusted by adjusting the clearance within the context of the method according to the disclosure, is a component of a brake system of a motor vehicle. The brake system can be an integrated brake system familiar to the person skilled in the art, which is a component unit in which a number of functions are combined in a compact design. The brake system can contain only one control unit for controlling the brakes present in the motor vehicle and an electrical connection to the control unit and an energy source, such as an engine or battery of the motor vehicle.

### BRIEF DESCRIPTION OF DRAWINGS

The method is explained in detail below using multiple figures. In the figures:

FIG. 1 shows a schematic block circuit diagram of a method for adapting the braking behaviour of a brake to a traffic situation;

FIG. 2a shows a schematic view of a brake, the clearance of which is set to a value L_{K} and FIG. 2b shows an enlargement of the schematic view of a brake from FIG. 2a;

FIG. 3 shows a schematic view of a brake, the clearance of which is reduced to zero as part of the adjustment;

FIG. 4 shows a schematic view of a brake with the clearance adjusted to a value L_{A}.

### DETAILED DESCRIPTION

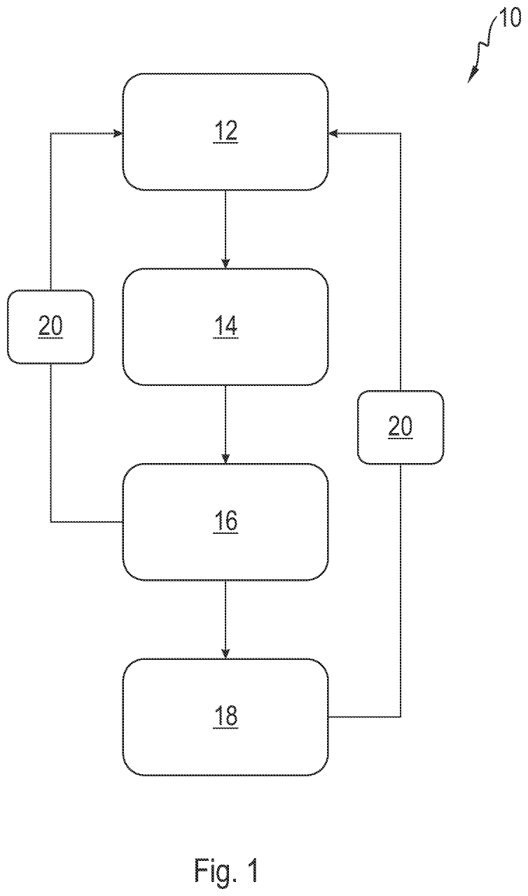

FIG. 1 shows a schematic view of a method 10 for adapting a braking behaviour of a brake 40 in the form of an electromechanical brake to a traffic situation. The brake 40, which is in the form, for example, of a wheel brake and which has a clearance 30 which is adjusted within the framework of the method 10 according to the disclosure, is a component of a brake system of a motor vehicle that is not shown. The brake system can be an integrated brake system, which is a unit in which a number of functions are combined in a compact design.

In the method 10, which is shown schematically in FIG. 1, a clearance 30 of the brake 40 is set to a value L_{K} in a first step 12. The clearance 30 can be set to the value L_{K} every time the motor vehicle is at a standstill 20 or stops, for example when the motor vehicle stops at a traffic light, at a pedestrian crossing, when turning off or parking the motor vehicle.

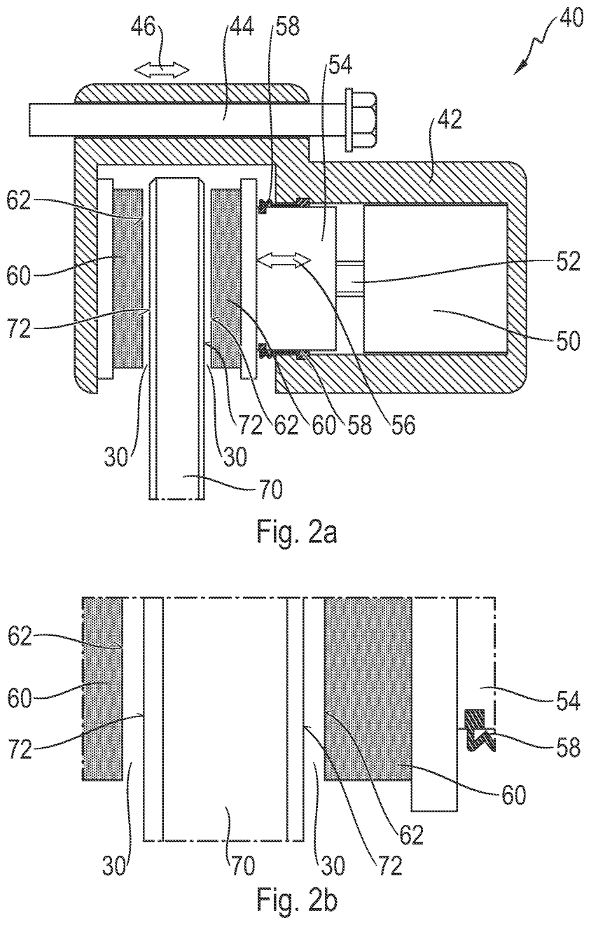

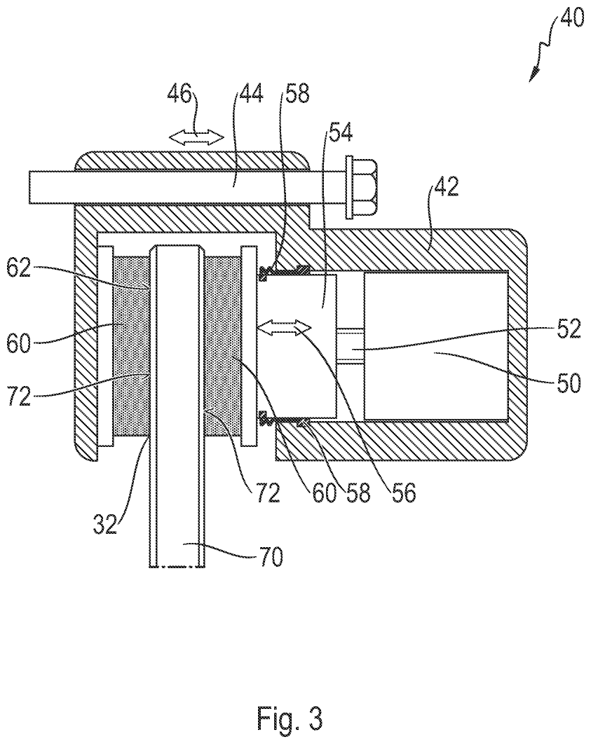

As can be seen from FIGS. 2a, 2b and 3, the brake 40 is in the form of a floating calliper brake here by way of example. The brake 40 has a housing 42 with a brake cylinder 48, in which a brake piston 54 is coaxially connected via a spindle 52 to a drive unit 50 containing a motor and a gearbox. The brake piston 54 is sealed from the brake cylinder 48 by a bellows 58 and can be operated by a driver by a brake pedal via the drive unit 50 and spindle 52.

When the brake 40 is actuated, the brake piston 54 with a first brake lining 60a arranged on it is displaced along a first travel path 56 by the spindle 52 and the drive unit 50 towards a brake disc 70 until a contact surface 62 of the first brake lining 60a contacts the friction surface 72 of the brake disc 70.

The brake piston 54 is supported by a housing 42 supported in a floating manner on a fastening device 44 and moving along a first travel path 46. The housing 42 grips the brake disc 70 laterally and allows a contact surface 62 of a second brake lining 60b to press against the friction surface 72 of the brake disc 70 from the other side.

In the present case, a control unit (not shown) in the form of a driver assistance system by way of example in conjunction with the drive unit 50, provides actuation of the brakes 40 on the basis, inter alia, of signals provided by sensors that are not shown, and provides corresponding driving and braking assistance functions. These driving and braking assistance functions are used for the purpose of autonomous or semi-autonomous driving and braking with increased safety and reliability.

In step 12 for adjusting the clearance 30, the contact surfaces 62 of the brake disc 70 and the friction surfaces 72 of the brake linings 60a, 60b are first brought into contact. For example, the contact of the contact surfaces 62 with the friction surfaces 72 can be detected by a distance sensor (not shown) which determines a distance 74 between the brake piston 54 and the drive unit 50 and a corresponding detection signal can be transmitted to the control unit. The clearance 30 takes a value of zero, as shown in FIG. 3.

Also in step 12, as can be seen from FIGS. 2a and 2b, the value L_{K} between the contact surface 62 and the friction surface 72 is set by retracting the brake piston 54. This can also be carried out with the distance sensor that is not shown. Signals generated by the distance sensor are transmitted to the control unit. After starting the vehicle, the housing 42 is moved along a second travel path 46 in such a way that the predetermined value L_{K}, in the present case by way of example 0.3 mm, is obtained on average between the first brake lining 60a and the friction surface 72 and between the second brake lining 60a and the friction surface 72. The brake 40 can also be in the form of a fixed calliper brake or of a drum brake.

In a second step 14, a driver situation is determined as an example traffic situation. In the present exemplary case, the determination of the driver's situation is carried out by sensors (not shown) attached to the brake pedal and the accelerator pedal. A sensor attached to the brake pedal may be adapted to detect whether the driver's foot is touching the brake 40 without applying it. Furthermore, the sensor attached to the accelerator pedal can be adapted to determine whether and to what extent the accelerator pedal is actuated. Signals generated by the sensors are transmitted to the control unit. Instead of the driver's situation, one or more other traffic situations, such as a driving situation, can also be determined.

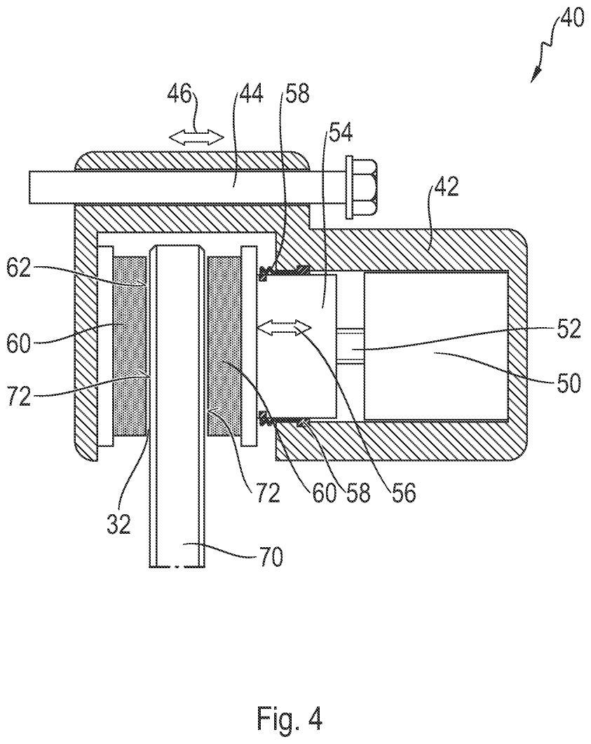

In a third step shown in FIG. 4, the clearance 16 is adjusted to a value L_{A} on the basis of the determined traffic situation, for example removal of a driver's foot from the accelerator pedal, wherein the condition 0<L_{A}<L_{K} is satisfied. The value L_{A} thus provides a clearance that is adapted or optimized to the respective traffic situation. This ensures that the clearance can be adapted to the current traffic situation in the best possible way. In addition, on the one hand too large a clearance which may involve a braking process that may take a long time or too long a time is avoided, and on the other hand too small a clearance which involves unnecessary wear and tear of the friction partners is avoided.

Once the clearance 30 has been adjusted to a value L_{A}, it is determined by sensor whether the vehicle is at a standstill 20. If the result is positive, the clearance 30 is set again by repeating step 12. As a result it can be ensured that all wheel brakes of the motor vehicle have the same clearance 30. As a result, any braking of the motor vehicle that may be necessary at a later date can be carried out evenly and without the motor vehicle swerving.

For example, readjusting the clearance 30 in step 18 to a value L_{B} can be carried out as soon as the driver's foot touches the brake 40 without applying it. In this case, it is assumed that the driver does indeed intend to apply the brake 40, so that the clearance 30 is further reduced to a value L_{K}, where 0<L_{B}<L_{A} applies. As a result, the clearance, and thus the braking behaviour, of the motor vehicle can be adapted or optimized to the current traffic situation.

For example, the readjustment explained above and made in step 18 can also be done in response to the driver pressing the accelerator pedal again. In this case, it is assumed that the driver intends not to apply the brake 40, so that the clearance 30 is increased to a value L_{B}, where L_{A}<L_{B}≤L_{K} is satisfied. After adjusting the clearance 30 to the value L_{B}, it is determined whether the motor vehicle is at a standstill 20. If the result is positive, the clearance 30 is set again according to step 12.

1. A method for adapting the braking behaviour of a brake of a motor vehicle to a traffic situation, including: adjusting a clearance of the brake to a value L_{K}; determining the traffic situation; and adjusting the clearance to a value L_{A} based on the determined traffic situation, where 0<L_{A}<L_{K} is satisfied.

2. The method according to claim 1, wherein the adjustment of the clearance to a value L_{K} is carried out when the motor vehicle is at a standstill, wherein the brake includes a brake lining with a contact surface and a friction surface, wherein adjusting the clearance to a value L_{K} involves contacting the contact surface with the friction surface and adjusting the value L_{K} between the contact surface and the friction surface.

3. The method according to claim 1, wherein the clearance is readjusted each time the motor vehicle is at a standstill.

4. The method according to claim 1, including determining a changed traffic situation; and adjusting the clearance to a value L_{B}, where 0<L_{B}≤L_{K} is satisfied with L_{B}≠L_{A}.

5. The method according to claim 1, wherein the traffic situation includes a driving situation and/or a driver situation.

6. The method according to claim 1, including determining a changed traffic situation; and adjusting the clearance to a value L_{B}, where 0<L_{B}<L_{A} is satisfied, wherein the traffic situation involves detection of a reduction in pressure exerted on an accelerator pedal of the motor vehicle, and the changed traffic situation involves detecting pressure exerted by touching or operating a brake pedal of the motor vehicle.

7. The method according to claim 1, wherein the brake is an electromechanical brake, wherein the motor vehicle has multiple brakes, wherein the clearance of each of the multiple brakes is adjusted individually or axle-by-axle.

8. The method according to claim 1, including the use of a control unit, of a driver assistance system to provide a first control signal for adjusting the clearance and a second control signal for adapting the clearance to the brake.

9. The method according to claim 8, including the use of a sensor adapted to determine the traffic situation and provide it to the driver assistance system, wherein the sensor is adapted to detect an operating state of the brake, an operating state of a wheel provided with the brake, an operating state of an engine, and/or an action of a driver of the motor vehicle, to determine a traffic situation concerning a brake pedal and/or accelerator pedal of the motor vehicle.

10. (canceled)

11. (canceled)

12. A system for adapting the braking behaviour of a brake of a motor vehicle to a traffic situation comprising:
a brake;
a control unit configured to:
adjust a clearance of the brake to a value L_{K};
determine the traffic situation; and
adjust the clearance to a value L_{A} based on the determined traffic situation, where 0<L_{A}<L_{K} is satisfied.

13. The system according to claim 12, wherein the adjustment of the clearance to a value L_{K} is carried out when the motor vehicle is at a standstill, wherein the brake includes a brake lining with a contact surface and a friction surface, wherein adjusting the clearance to a value L_{K} involves contacting the contact surface with the friction surface and adjusting the value L_{K} between the contact surface and the friction surface.

14. The system according to claim 12, wherein the clearance is readjusted each time the motor vehicle is at a standstill.

15. The system according to claim 12, wherein the control unit is further configured to determine a changed traffic situation; and adjust the clearance to a value L_{B}, where 0<L_{B}≤L_{K} is satisfied with L_{B}≠L_{A}.

16. The system according to claim 12, wherein the traffic situation includes a driving situation and/or a driver situation.

17. The system according to claim 12, wherein the control unit is further configured to determine a changed traffic situation; and adjust the clearance to a value L_{B}, where 0<L_{B}<L_{A} is satisfied, wherein the traffic situation involves detection of a reduction in pressure exerted on an accelerator pedal of the motor vehicle, and the changed traffic situation involves detecting pressure exerted by touching or operating a brake pedal of the motor vehicle.

18. The system according to claim 12, wherein the brake is an electromechanical brake, wherein the motor vehicle has multiple brakes, wherein the clearance of each of the multiple brakes is adjusted individually or axle-by-axle.

19. The system according to claim 12, wherein the control unit comprises a driver assistance system control unit to provide a first control signal for adjusting the clearance and a second control signal for adapting the clearance to the brake.

20. The system according to claim 19, further comprising a sensor adapted to determine the traffic situation and provide it to the driver assistance system control unit, wherein the sensor is adapted to detect an operating state of the brake, an operating state of a wheel provided with the brake, an operating state of an engine, and/or an action of a driver of the motor vehicle, to determine a traffic situation concerning a brake pedal and/or accelerator pedal of the motor vehicle.
